(19) United States
(12) Patent Application Publication
(10) Pub. No.: US 2021/0326146 A1
(43) Pub. Date: Oct. 21, 2021

(54) INSTALLATION PACKAGE FOR USE WITH HETEROGENEOUS OPERATING SYSTEMS

(71) Applicant: Hewlett-Packard Development Company, L.P., Spring, TX (US)

(72) Inventors: Ajay SHARMA, Huntington Beach, CA (US); Hyoeun KIM, Seongnam-si (KR); Semen ABYKOV, Seongnam-si (KR); Wuseok JANG, Seongnam-si (KR); Yunjong LEE, Seongnam-si (KR); Juho EUM, Seongnam-si (KR)

(21) Appl. No.: 17/273,036

(22) PCT Filed: Oct. 25, 2018
(86) PCT No.: PCT/US2018/057541

§ 371 Date: Mar. 3, 2021

(51) Int. Cl. G06F 9/4401; G06F 21/57; G06F 8/65

(52) U.S. Cl. CPC G06F 9/4406; G06F 8/65; G06F 21/572

(57) ABSTRACT

An application installation file for multiple operating systems (OSs), a method of installing an application for multiple OSs, and an electronic apparatus for installing an application installation file for multiple OSs are provided. The application installation file includes a first container including application meta data corresponding to the plurality of heterogeneous operating systems, a second container including application installation files corresponding to the plurality of heterogeneous operating systems, a third container including asset information for each of the application installation files, and a fourth container including certification information for the file structure.

### BACKGROUND

An electronic apparatus may be provided with an operating system (OS) to control its operation. The electronic apparatus may also be provided with one or more applications, controlled by the OS, to implement various functions. For example, in a case in which the electronic apparatus is a multi-function printer (MFP), the MFP may include an application for printing, an application for copying, an application for scanning, etc., each application being controlled by the OS when selected by a user. With advances in technology, an electronic apparatus may be provided with multiple OSs of different types, that is, heterogeneous OSs. In that case, a wider variety of applications may be obtained for use on the electronic apparatus.

### BRIEF DESCRIPTION OF DRAWINGS

The above and other aspects, features, and advantages of certain examples of the present disclosure will be more apparent from the following description taken in conjunction with the accompanying drawings, in which:

FIG. 1 illustrates an electronic apparatus, according to an example;

FIG. 2 illustrates a system partition in a processor of an electronic apparatus having heterogenous operating systems (OSs), according to an example;

FIG. 3 illustrates an application installation package for a single OS;

FIG. 4 is a block diagram illustrating an application installation package for an electronic apparatus using heterogeneous OSs, according to an example;

FIG. 5 is a block diagram illustrating in more detail an application installation package for heterogeneous OSs, according to an example;

FIG. 6 is a block diagram illustrating a meta data container of an application installation package, according to an example;

FIG. 7 is a schematic block diagram illustrating a system and method for installing an application installation package for heterogenous OSs, according to an example;

FIG. 8 is a flow diagram illustrating a method of installing an application installation package for heterogenous OSs, according to an example;

FIG. 9 is a schematic block diagram illustrating a method of installing an application installation package for heterogenous OSs, according to an example;

FIGS. 10A-10C are block diagrams illustrating meta data containers for implementing the application of FIG. 9, according to an example; and

FIG. 11 illustrates an application installation package for implementing the application of FIG. 9, according to an example.

Throughout the drawings, it should be noted that like reference numbers are used to depict the same or similar elements, features, parts, components, and structures and thus, a repeated description thereof may be omitted.

### DETAILED DESCRIPTION OF EXAMPLES

Hereinafter, various examples will be described with reference to the accompanying drawings. In this regard, the examples may have different forms and should not be construed as being limited to the descriptions set forth herein. In order to further clearly describe features of the examples, descriptions of other features that are well known to one of ordinary skill in the art are omitted here.

Expressions such as “at least one of,” when preceding a list of elements, modify the entire list of elements and do not modify the individual elements of the list.

In the specification, when an element is “connected” to another element, the elements may not only be “directly connected,” but may also be “connected” via another element therebetween, unless otherwise described. Also, when a region “includes” an element, the region may further include another element instead of excluding the other element, unless otherwise differently stated.

In the following description, an electronic apparatus may refer to, but is not limited to, an image forming apparatus (IFA) such as a printer, a copier, a scanner, a facsimile machine, or a multi-functional printer (MFP) which may include two or more of such functions. Further, an electronic apparatus may refer to, but is not limited to, a smartphone, a tablet personal computer (PC), a mobile phone, a video telephone, an electronic book reader, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device (for example, smart glasses, head-mounted-devices (HMDs), or smart watches). In addition, an electronic apparatus may refer to, but is not limited to, a smart home appliance such as a television (TV), a digital versatile disc (DVD) player, a refrigerator, an air conditioner, a washing machine, a set-top box, a home automation control panels, an electronic picture frame, or the like.

In the following description, an operating system (OS) may refer to, but is not limited to, an OS that is provided with an electronic apparatus by a manufacturer, an OS that is provided by an external supplier, or the like. Examples of OSs may include Microsoft Windows™, Apple macOS™, Google Android™, Apple iOS™, Linux OS™, Chrome OS™, BlackBerry Tablet OS™ and the like.

It is to be understood that blocks in the accompanying block diagrams and compositions of operations in flowcharts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in the block diagrams or the operations in the flowcharts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the operations in the flowcharts. Also, the computer program instructions can be loaded onto the computer or the computer programmable data processing apparatus. Therefore, a series of operations is performed in the computer or the programmable data processing apparatus to generate a process executed by the computer, which makes it possible for the instructions driving the computer or the programmable data processing apparatus to provide operations of executing the functions described in the blocks of the block diagrams or the operations of the flowcharts.

Each block or operation may indicate a portion of a module, a segment or a code including one or more executable instructions to perform a specific logical function (or functions). It should be noted that, in some examples, the functions described in the blocks or the operations may be generated out of order. For example, two blocks or operations that are continuously shown can be actually performed at the same time, or they can sometimes be performed in reverse order according to the corresponding functions.

Each of the respective components in the following examples refers to, but is not limited to, a software or hardware component, such as a Field Programmable Gate Array (FPGA), an Application Specific Integrated Circuit (ASIC), or the like. A module may be advantageously configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a security multimedia card.

As technology has progressed, an electronic apparatus may be provided with multiple OSs of different types, that is, heterogeneous OSs. By including two or more heterogenous OSs, the electronic apparatus is able to support a wider array of applications, thus expanding the program capability and coverage of the electronic apparatus for greater user convenience. For example, in a case in which an electronic apparatus includes two heterogeneous OSs, a user may select and install an additional application that combines or uses capabilities of both OSs.

An application installation package for use with an electronic apparatus having multiple heterogeneous OSs, an electronic apparatus having multiple heterogeneous OSs, and a method for installing the application installation package will now be described more fully with reference to the accompanying drawings, in which various examples are shown.

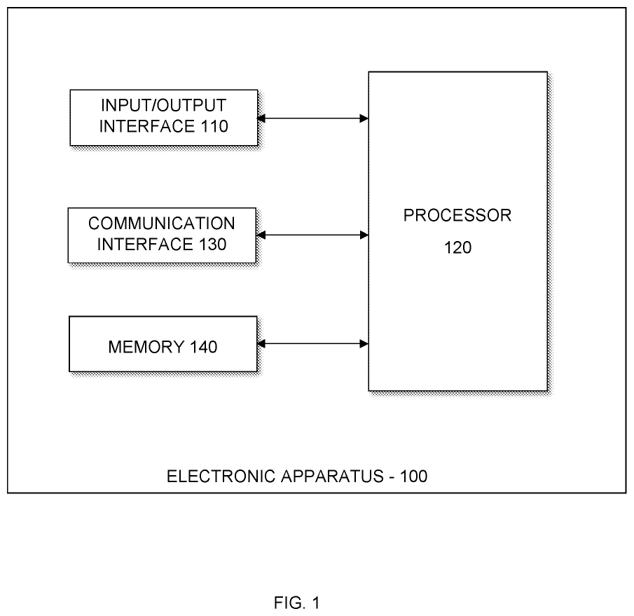

FIG. 1 illustrates an electronic apparatus, according to an example.

Referring to FIG. 1, an electronic apparatus 100 may include an input/output interface 110, a processor 120, a communication interface 130, and a memory 140. Although not illustrated, the electronic apparatus 100 may further include a power supply for supplying power to each component.

The input/output interface 110 may include an input interface for receiving an input for performing an application or executing a function from a user, and an output interface for displaying information, such as a result of performing an application, executing a function, or a state of the electronic apparatus 100. For example, the input/output interface 110 may include an operation panel for receiving a user input and a display panel for displaying a screen.

In more detail, the input interface may include a device for receiving various types of user inputs, such as a keyboard, a physical button, a touch screen, a camera, a microphone, or the like. Also, the output interface may include, for example, a display panel, a speaker, or the like. However, the input/output interface 110 is not limited thereto and may include any device supporting various inputs and outputs.

The processor 120 may control overall operations of the electronic apparatus 100, and may include at least one processor, such as a central processing unit (CPU). The processor 120 may control other components included in the electronic apparatus 100 to perform an operation corresponding to a user input received through the input/output interface 110. In that regard, the processor 120 may include two or more OSs for controlling operations of the electronic apparatus 100 and for controlling applications installed on the electronic apparatus and stored in the memory 140. Furthermore, the OSs may be heterogeneous OSs.

The processor 120 may include at least one specialized processor for each function or may be an integrated processor. For example, the processor 120 may execute a program stored in the memory 140, read data or a file stored in the memory 140, or store a new file in the memory 140. The processor 120 may also include an application specific integrated circuit (ASIC) that may be partitioned for use with the plurality of OSs.

The communication interface 130 may communicate with another device or a network in a wired or wireless manner. To this end, the communication interface 130 may include a communication module, such as a transceiver, supporting at least one of various wired/wireless communication methods. For example, the communication module may be in a form of a chipset, may be a sticker/barcode (for example, a sticker including a near-field communication (NFC) tag) containing information required for communication, or the like.

The wireless communication may include at least one of, for example, wireless fidelity (Wi-Fi), Wi-Fi direct, Bluetooth, ultra-wideband (UWB), NFC, or the like. The wired communication may include at least one of, for example, a universal serial bus (USB), a high definition multimedia interface (HDMI), or the like.

The communication interface 130 may be connected to an external apparatus located outside the image forming apparatus 100 to transmit or receive a signal or data and may be connected to a server to transmit or receive a signal or data. For example, the communication interface 130 may be connected to an external device such as a cloud server to receive an application for use on the electronic apparatus 100.

Names of the above components of the electronic apparatus 100 may be changed. Also, the electronic apparatus 100 may include at least one of the above components, and may not include some of the above components or may further include an additional component.

FIG. 2 illustrates a system partition in a processor of an electronic apparatus having heterogenous OSs, according to an example.

Referring to FIG. 2, a processor of an electronic apparatus may be implemented to include an ASIC 209 which is a multi-core CPU. A first OS 205 and a second OS 207 may be installed on the different core of ASIC 209 in order to control operations of the electronic apparatus as well as control execution of applications using either or both OSs. In this example, the first OS 205 and the second OS 207 are heterogeneous OSs. Notably, although two OSs are illustrated in FIG. 2, this is only for purpose of illustration and there may be three or more OSs provided.

In the example of FIG. 2, it may be assumed that a user has requested and received an application that combines the capabilities of both the OS1 205 and the OS2 207. In that case, a vendor or other supplier of the application provides an application 1 201 corresponding to the OS 1 205 and an application 2 203 corresponding to the OS 2 207 for installation on the ASIC 209 of the electronic apparatus. To supply the application 1 201 and the application 2 203, the vendor or supplier must provide the user with an application installation package for each OS.

Installation or setup of an application installation package, including for example device drivers, plugins, etc., is the process of making the application ready for execution. For installation of an application installation package into an embedded OS, such as OS1 205 or OS 2 207, the application installation package is written in a programming language that depends on the OS, or its framework. Because the installation process varies based on the specifics of the program, the electronic apparatus, the operating system, etc., the application installation package and/or the OS is typically provided with an installer, which is a specialized program responsible for installation of the application installation package. Installation typically involves code being copied and/or generated from the application installation package to new files on the electronic apparatus for easier access by the OS.

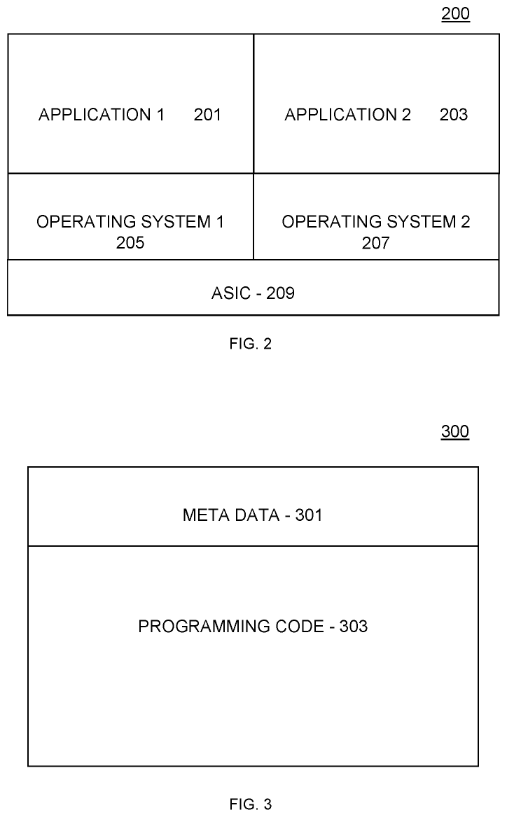

FIG. 3 illustrates an application installation package for a single OS.

Referring to FIG. 3, an application installation package 300 for a single OS includes a meta data section 301 and a programming code section 303. The meta data section 301 may include configuration information of the application related to the single OS. The programming code section 303 may include coding or other data (e.g., binary data) for use in installing the application installation package for the single OS related to the installation file 300.

Considering the use of the application installation package 300 for installation of the application in the example of FIG. 2, it would be necessary for a supplier of the application to supply a first application installation package 300 corresponding to the OS 1 205 and a second application installation package 300 corresponding to the OS 2 207. That is, if a user selects an application that is implemented across multiple heterogeneous OSs (i.e., OS 1 205 and OS 2 207), an application installation package 300 must be received and installed by the user for each of the heterogeneous OSs. In that case, each application installation package 300 for the different OSs would need to be installed and may need to be installed in a certain order, either of which may cause confusion or other inconvenience for the user. Furthermore, because the meta data 301 carries configuration information of the application, an application that makes use of two different OSs makes it difficult to achieve solution scalability.

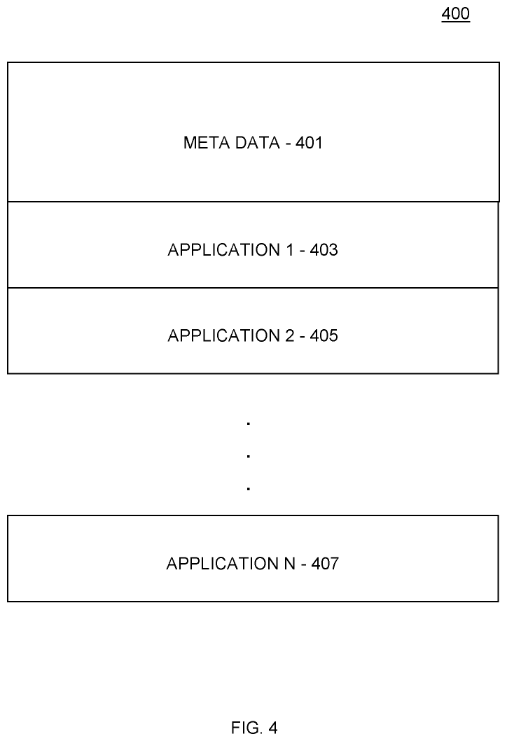

FIG. 4 is a block diagram illustrating an application installation package for an electronic apparatus using heterogeneous OSs, according to an example.

Referring to FIG. 4, an application installation package 400 includes a meta data folder 401, an application 1 folder 403, an application 2 folder 405, and an application n folder 407.

In contrast to the application installation package 300, the application installation package 400 is an application installation package that includes meta data and application installation files for each of N OSs. For example, if an application is developed that combines the capabilities of three different OSs, the meta data folder 401 of the application installation package 400 would include meta data for each of the three different OSs. Similarly, the application installation package 400 would include the application 1 folder 403, the application 2 folder 405 and, because N=3 in this example, the application 3 folder 407. That is, the application installation package would archive a variety of application and meta data associated with each of the corresponding OSs.

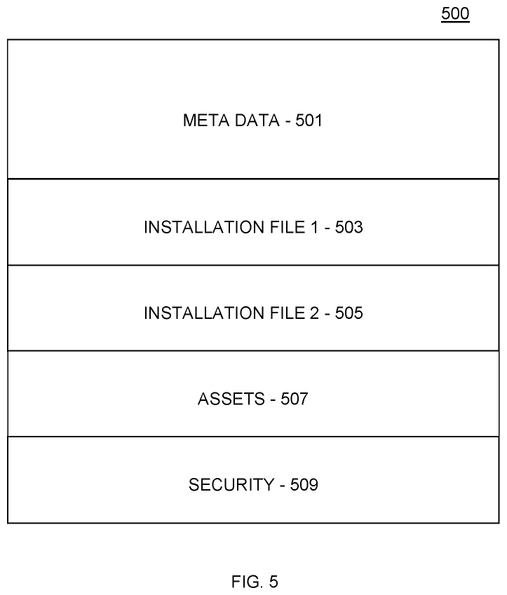

FIG. 5 is a block diagram illustrating in more detail an application installation package for heterogeneous OSs, according to an example.

Referring to FIG. 5, an application installation package 500 includes a meta data container 501, a first installation file container 503, a second installation file container 505, an assets container 507, and a security container 509.

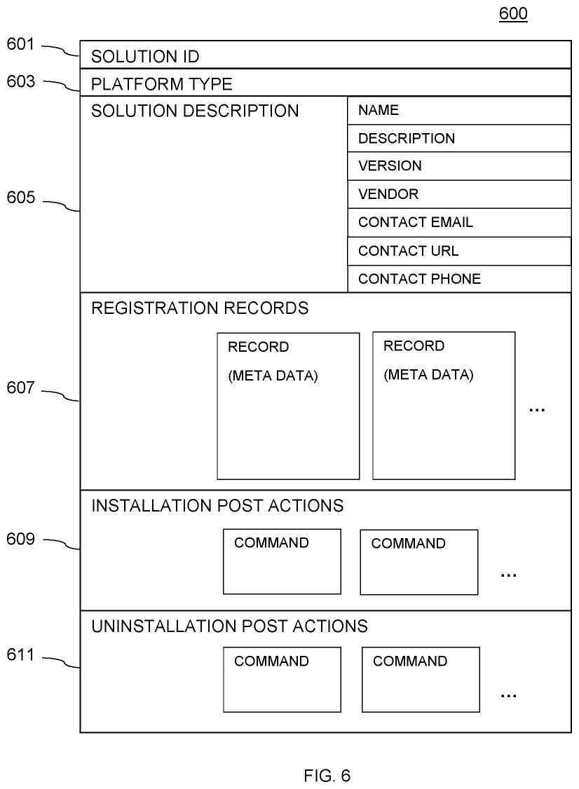

The meta data container 501 includes application meta data corresponding to each of a plurality of OSs installed on an electronic apparatus. In an example, the meta data container includes information in a javascript object notation (JSON) format or an extensible markup language (xml) format. The contents of the meta data container will be explained in more detail with reference to FIG. 6.

In the example of FIG. 5, it is assumed that the application combines the capabilities of two OSs installed on the electronic apparatus that is to receive the application installation package 500. Thus, the application installation package 500 includes the first installation file container 503 and the second installation file container 505, each installation file container corresponding to one of the two OSs. That is, the first installation file container 503 and the second installation file container 505 each includes an installation file for one of the corresponding OSs. For example, if the application installation package 500 was for an application that made use an Android OS and a Linux OS, the first installation file container 503 may include an installation file (i.e., an .apk extension file) for installation on the Android OS, while the second installation file container 505 may include an installation file (i.e., a .tar.gz extension file) for installation on the Linux OS. Of course, the example of FIG. 5 corresponding to two OSs is only for example and it is to be understood that the application installation package 500 may be used for any number of OSs. In that regard, for each additional OS, the application installation package 500 would include an additional installation file container corresponding to the additional OS.

The assets container 507 may include information or files related to resources needed for execution of the application. For example, the assets container 507 may include information or files necessary to provide a user interface (UI) for execution of the application.

The security container 509 may include information or files necessary for security of the application as well as general information necessary to include in the application installation package 500. For example, the security container 509 may include information or files for the application's certification, or may include directory information (e.g., a meta-inf file) about various files included in the application installation package 500.

In an example, the application installation package 500 may be a zip file that archives binary files of a certain application corresponding to an OS and meta data. Furthermore, in an example, the content of the application installation package 500 may be zipped by the vendor of the application and provided to a user.

FIG. 6 is a block diagram illustrating a meta data container of an application installation package, according to an example.

Referring to FIG. 6, a meta data container 600 includes a solution identification (ID) field 601, a platform type field 603, a solution description field 605, a registration records field 607, an installation post actions field 609, and an uninstallation post actions field 611.

The solution ID field 601 may include an identifier or identification information to distinguish the application and its corresponding OS. The solution ID field 601 may be an alphanumeric identifier or any type of string. The platform type field 603 refers to the OS on which the corresponding application going to be installed. For example, the platform type field 603 may refer to Android OS, Windows OS, Linux OS, etc. The solution description field 605 includes basic information regarding the application. For example, the solution description field 605 may include information about a name of the application, a description of the application, a version of the application, a vendor of the application, a contact email for the application, a contact uniform resource locator for the application, and a phone number for a contact who may be responsible for or otherwise assist with the application. The registration records field 607 may include various files, data, or information regarding a configuration of the application. For example, the registration records field 607 may define a data structure for the application, or the like.

The installation post actions field 609 may include information or files concerning actions that are to take place after installation of an application installation file. That is, the installation post actions field 609 may include a command for an action that must be done at the time of application installation or after installation success. For example, if it is necessary to perform a system reboot following the installation of an application installation file, such a command may be included in the installation post actions field 609. The installation post actions field 609 may include other or additional commands such as custom authentication, quota agents, provider set up, or the like. These are system information that must be declared before the first run of an installed application. The uninstallation post actions field 611 may include information or files concerning actions that are to take place before or as part of uninstallation of an application installation file. That is, the commands of the uninstallation post actions field 611 may be similar to those of the installation post action field 609 with a difference being that the uninstall commands are performed before the application file is removed. In other words, before removal of an application from an OS, the uninstallation post actions field 611 describes what kind of commands shall be done for removing the application from the OS.

The meta data container 600 would be dedicated to one OS that is included in an application installation package, such as the application installation package 500 of FIG. 5. Thus, in the example of FIG. 5 that is addressed to an application for two OSs, the meta data container 501 would include a meta data container 600 for each OS.

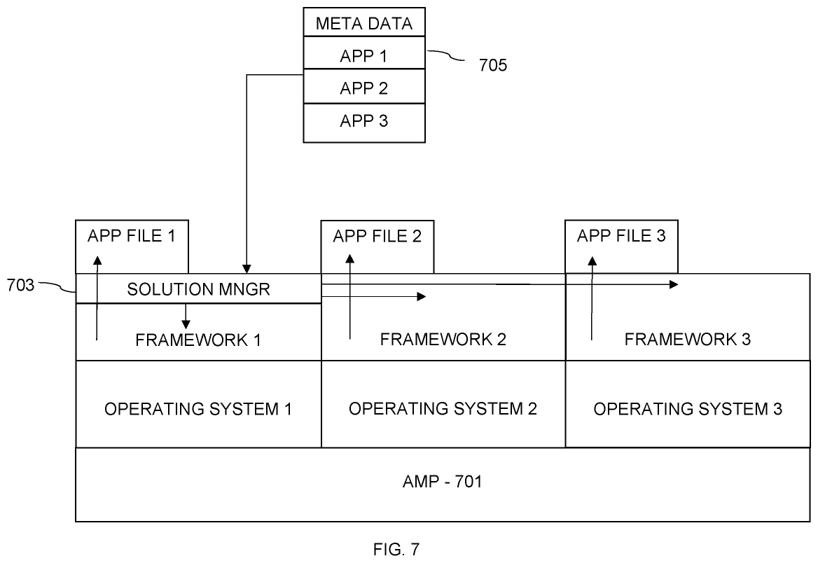

FIG. 7 is a schematic block diagram illustrating a system and method for installing an application installation package for heterogenous OSs, according to an example.

Referring to FIG. 7, an electronic apparatus may include one or more processor (not illustrated), wherein the one or more processor may control a plurality of OSs. For example, the electronic apparatus may include a plurality of processors, each respectively controlling an OS. Alternatively, the electronic apparatus may logically partition a single processor into a number of partitions corresponding to the number of OSs. Although the OSs may be of the same type in such a system, for the example of FIG. 7, it is assumed that the OSs (i.e., OS1, OS2, and OS3) are each different from one another. In the example of FIG. 7, the one or more processor is illustrated as an asymmetric multi-processing (AMP) layer 701.

In the AMP layer 701, it is assumed that there is one master processor that provides overall control of the electronic apparatus and two slave processors. In the example of FIG. 7, the processor associated with OS1 is considered as the master processor such that the processors respectively associated with OS2 and OS3 are considered slave processors. Each of OS1, OS2, and OS3 includes a corresponding architecture or framework (i.e., framework 1, framework 2, and framework 3). As illustrated in FIG. 7, the framework 1, corresponding to the OS1 and the master processor, also includes a solution manager 703. The solution manager 703 may be implemented as a software module included in firmware of the electronic apparatus and is responsible for receiving, installing, and uninstalling an application installation package 705.

In an example illustrated in FIG. 7, it is assumed that a user desires to install an application that combines the capabilities of all three OSs (i.e., OS1, OS2, and OS3). For example, referring to FIG. 1, a user may input a request for the application using the input/output interface 110, and the request may be transmitted to the application supplier using the communication interface 130. Upon receiving the request, the application installation package 705 may be provided to the electronic apparatus by the application supplier, such as by an application vendor, a manufacturer of the electronic apparatus, etc. in more detail, the installation or uninstallation of the requested application may be initiated by an internal function call from a client in the same system, for example the framework 1 of OS 1. In another example, the installation or uninstallation of the application may be based on a web service request from a client, the client being within the system or outside of the system.

After the application installation package 705 is received, the solution manager 703 unzips the application installation package 705 and parses information included therein. For example, the solution manager 703 may parse the meta data included in the application installation package 705 and determine to which of the OSs the application corresponds. After analyzing the meta data or other information, the solution manager 703 may call a corresponding command to a desired OS and framework for each archived application. For example, the solution manager 703 may call a corresponding command to framework 2 of OS 2 for installation of application file 2 corresponding to framework 2. Similarly, the solution manager 703 may call a corresponding command to framework 3 of OS 3 for installation of application file 3 corresponding to framework 3. After successful installation on each desired OS framework, the solution manager 703 may perform a post action which is defined in the installation post actions field in the application installation package 705, such as the installation post actions field 609 of FIG. 6.

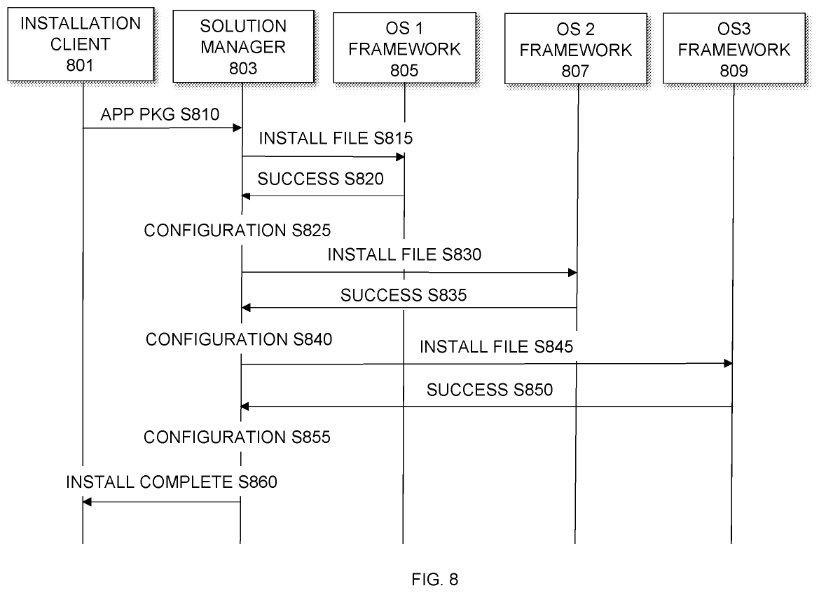

FIG. 8 is a flow diagram illustrating a method of installing an application installation package for heterogenous OSs, according to an example.

Referring to FIG. 8, an installation client 801 may provide an application installation package to a solution manager 803 in operation S810. As an example, a user of an electronic apparatus including the solution manager 803 may request the installation client 801 to provide the application installation package. As another example, a manager of the electronic apparatus may push the application installation package from the installation client 801 to the electronic apparatus for receipt by the solution manager 803 when certain conditions are met, for example a version upgrade of the application, or the like.

In operation S815, the solution manager 803 provides an installation file corresponding to a first OS to a first OS framework 805. For example, if the first OS framework 805 is an Android framework, the solution manager 803 may provide an .apk file to the first OS framework 805. In operation S820, the first OS framework 805 provides an indication that installation of the received installation file was a success. Upon receiving an indication that the installation of the application file on the first OS framework 805 was a success, the solution manager 803 may perform an OS1 configuration related to the application in operation S825. That is, the solution manager 803 may perform an action that is provided in an installation post actions field, such as the installation post actions fields 609 of FIG. 6. For example, the solution manager 803 may install an icon corresponding to the application.

In operation S830, the solution manager 803 provides an installation file corresponding to a second OS to a second OS framework 807. For example, if the second OS framework 807 is a Windows framework, the solution manager 803 may provide a .dll file to the second OS framework 807. In operation S835, the second OS framework 807 provides an indication that installation of the received installation file was a success. Upon receiving an indication that the installation of the application file on the second OS framework 807 was a success, the solution manager 803 may perform an OS2 configuration related to the application in operation S840, based on a command included in an installation post actions field of the meta data.

In operation S845, the solution manager 803 provides an installation file corresponding to a third OS to a third OS framework 809. For example, if the third OS framework 809 is a Linux framework, the solution manager 803 may provide a .tar.gz file to the third OS framework 809. In operation S850, the third OS framework 809 provides an indication that installation of the received installation file was a success. Upon receiving an indication that the installation of the application file on the third OS framework 809 was a success, the solution manager 803 may perform an OS3 configuration related to the application in operation S855, based on a command included in an installation post actions field of the meta data.

In operation S860, the solution manager 803 may provide an indication to the installation client 801 that the installation was completed. The solution manager 803 may also provide additional information to the installation client such as registration information of the application.

In the following description, a more specific example is provided regarding an application installation package and its installation in an electronic apparatus including a plurality of heterogeneous OSs.

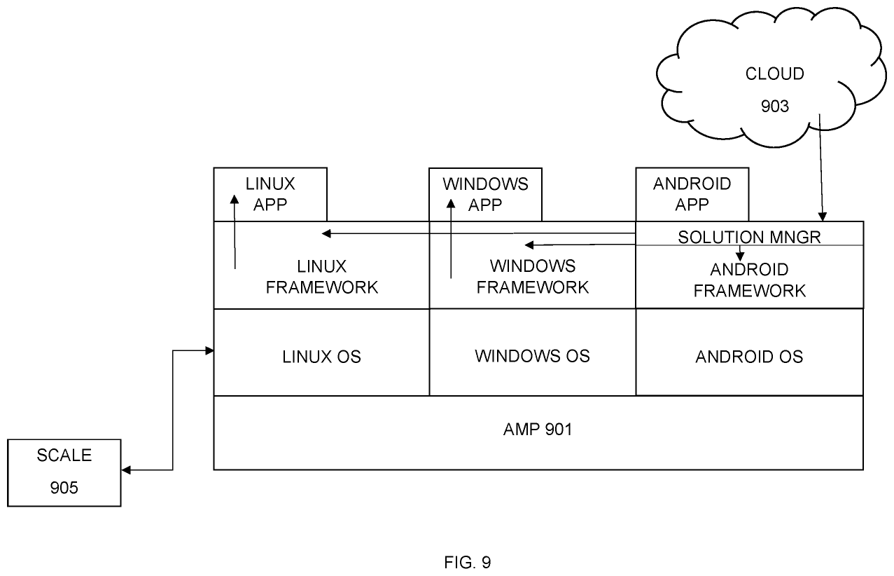

FIG. 9 is a schematic block diagram illustrating a system and method for installing an application installation package for heterogenous OSs, according to an example.

Referring to FIG. 9, an example is provided in which an electronic apparatus is implemented as an image forming apparatus. In the example of FIG. 9, it is assumed that the image forming apparatus includes an AMP layer 901 in which a partitioned processor or a plurality of processors respectively support a Linux OS and Linux framework, a Windows OS and Windows framework, and an Android OS and Android framework, and that the processor or partition associated with the Android OS is the master processor. Although not shown, the image forming apparatus may be implemented to include components similar to those of the electronic apparatus of FIG. 1, including an input/output interface, a communication interface, and a memory, as well as the one or more processors that support the OSs and frameworks. Using the communication interface, the image forming apparatus may be connected to an external server, such as a cloud server 903. The image forming apparatus is also connected to a scale 905. In various examples, the scale 905 may be integrated with the image forming apparatus or may be an external component.

Further to the example of FIG. 9, it may be assumed that an application is available that allows a user to weigh a parcel using the scale 905, input a desired shipping address for the parcel, transmit the weight and address information to the application provider, and receive information including costs for printing a label to ship the parcel. In that case, a user of the image forming apparatus may use the input/output interface to request the application and the request may be forwarded to the cloud server 903 using the communication interface.

For implementation of the application in the image forming apparatus of FIG. 9, there are three points to consider. First, it is necessary to enable a driver for the scale 905 to provide weight information to the image forming apparatus. Second, it is necessary to control an image composer, such as a printer of the image forming apparatus, in order to print out a label. Third, it is necessary to provide a public or private connection to the could server 903. In the heterogeneous operating system of FIG. 9, these three requirements may be achieved by collaborating among the OSs and frameworks to leverage easy development. For example, the driver for the scale 905 may be installed and controlled by the Linux OS and framework. Also, if the printer of the image forming apparatus is controlled by the Windows OS and framework, then the image composer may be performed under the Windows OS and framework. Moreover, the Android OS and framework may provide a public/private connection and session control with the cloud server 903 as long as the cloud vendor exposes Android API for mobile and tablet devices.

To implement the above described application that makes use of functions associated with heterogeneous OSs, it is advantageous to provide a single application installation package, as opposed to three distinct application packages, each of which must be installed separately by a user, perhaps in a specific order, thus causing an inconvenience and confusion for the user.

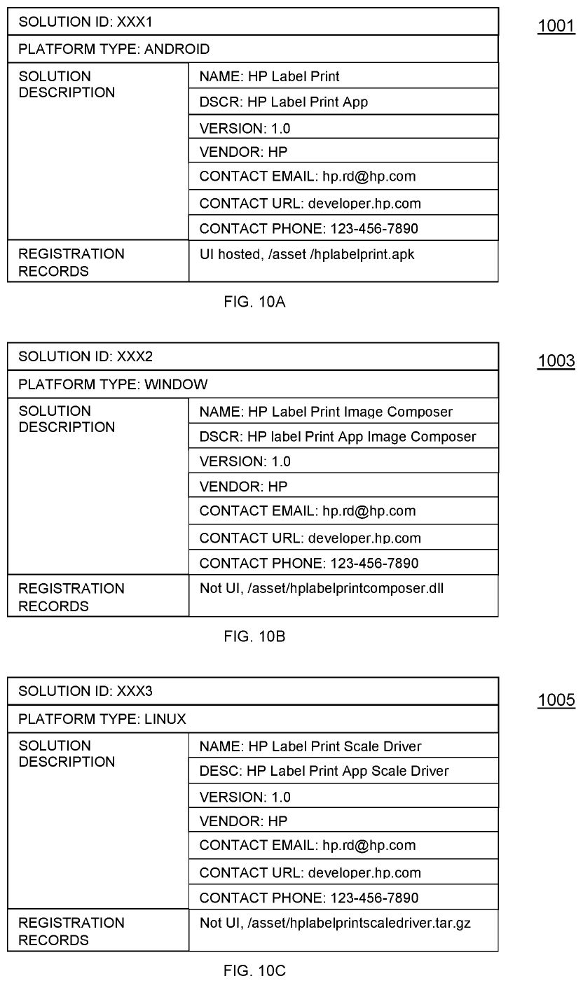

FIGS. 10A-10C are block diagrams illustrating meta data containers for implementing the application of FIG. 9, according to an example.

Referring to FIGS. 10A-10C, a first meta data container 1001, a second meta data container 1003, and a third meta data container 1005 are provided.

Each of the first meta data container 1001, the second meta data container 1003, and the third meta data container 1005 includes various fields such as those described above with reference to FIG. 6. For example, each of the first meta data container 1001, the second meta data container 1003, and the third meta data container 1005 includes a solution ID field which includes an identifier or identification information to distinguish the application. Each of the first meta data container 1001, the second meta data container 1003, and the third meta data container 1005 also includes a platform type field that indicates to which of the OSs of the image forming apparatus the meta data corresponds. For example, the platform type field of the first meta data container 1001 indicates it corresponds to the Android OS. Similarly, the platform type field of the second meta data container 1003 indicates it corresponds to the Window OS and the platform type field of the third meta data container 1003 indicates it corresponds to the Linux OS. Each of the first meta data container 1001, the second meta data container 1003, and the third meta data container 1005 further includes a solution description field that provides basic information regarding the application such as a name of the application, a description of the application, a version of the application, a vendor of the application, a contact email for the application, a contact URL for the application, and a phone number for a contact associated with the application.

Each of the first meta data container 1001, the second meta data container 1003, and the third meta data container 1005 is also provided with a registration records field. In the example of FIG. 9, it is noted that the scale driver associated with the Linux OS and the image composer associated with the Windows OS may not have a user interface (UI) that a customer uses so that only Android application would implement a UI activity. In that case, the registration records field associated with the first meta data container 1001 may indicate that the Android OS based component of the application is UI hosted, whereas the second meta data container 1003 and the third meta data container 1005 may indicate that the Windows OS and Linux OS based components of the application are not UI hosted.

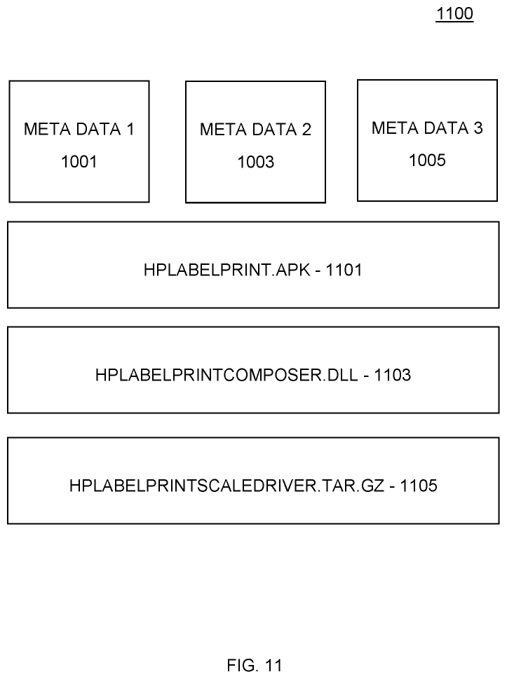

FIG. 11 illustrates an application installation package for implementing the application of FIG. 9, according to an example.

Referring to FIG. 11, an application installation package 1100 includes the meta data containers 1001, 1003, and 1005, respectively illustrated in FIGS. 10A-10C, as well as an installation file container 1101 corresponding to the Android OS, an installation file container 1103 corresponding to the Windows OS, and an installation file container 1105 corresponding to the Linux OS.

To create the application installation package 1100, the meta data containers 1001, 1003, and 1005, and the binary data file containers 1101, 1103, and 1105 corresponding to each of the three OSs, are combined using a zipping process. As discussed above, each meta data container 1001, 1003, and 1005 has a registration record to guide where the corresponding application is zipped. In implementation, the application installation package may be made using a simple compression application program based on open source of archive and compression as a standard.

A method as described above may be implemented in a form of a computer-readable storage medium storing data or instructions executable by a computer or a processor. The method may be written as a computer program and may be implemented in general-use digital computers that execute the programs using a non-transitory computer-readable storage medium. Examples of the computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disk (SSD), and any devices that may store instructions or software, related data, data files, and data structures and may provide instructions or software, related data, data files, and data structures to a processor or a computer to allow the processor or the computer to execute instructions.

While the present disclosure has been described with reference to the drawings and particular examples, those of ordinary skill in the art may make various changes and modifications therein without departing from the spirit and scope of the present disclosure. For example, the described techniques may be performed in a different order than the described method, and/or the described components such as systems, structures, devices, and circuits may be united or combined in a different form than the described method or may be replaced or substituted by other components or equivalents thereof.

What is claimed is:

1. A computer readable medium embodying a file structure for installation of an application on an electronic apparatus including a plurality of heterogeneous operating systems, the file structure comprising:
a first container including application meta data corresponding to the plurality of heterogeneous operating systems;
a second container including application installation files corresponding to the plurality of heterogeneous operating systems;
a third container including asset information for each of the application installation files; and
a fourth container including certification information for the file structure.

2. The computer readable medium of claim 1, wherein the first container includes a plurality of sets of application meta data respectively corresponding to the plurality of heterogeneous operating systems.

3. The computer readable medium of claim 2, wherein each set of application meta data comprises:
an identifier of the application;
an identifier of one of the plurality of operating systems that corresponds to the meta data;
a registration record for the application; and
at least one action record for the application.

4. The computer readable medium of claim 3, wherein the at least one action record comprises at least one of:
an installation post action record including a command to be executed upon installation of the application on the electronic apparatus; or
an uninstallation post action record including a command to be executed upon removal of the application from the electronic apparatus.

5. The computer readable medium of claim 4, wherein the command to be executed upon installation of the application is completed before execution of the application.

6. The computer readable medium of claim 1, wherein the second container includes a plurality of installation files respectively corresponding to the plurality of heterogeneous operating systems.

7. The computer readable medium of claim 1, wherein a format of the meta data comprises at least one of extensible markup language (XML) or javascript object notation (JSON).

8. An electronic apparatus including a plurality of heterogeneous operating systems, the electronic apparatus comprising:
an input/output interface;
a memory to store instructions; and
at least one processor,
wherein the at least one processor executes the instructions to:
receive a file for installation of an application on the plurality of heterogeneous operating systems,
parse the file, and
control installation of the application on each of the plurality of heterogeneous operating systems.

9. The electronic apparatus of claim 8, wherein the processor controls the installation of the application on each of the plurality of heterogeneous operating systems by controlling to install a first installation file of the application corresponding to a first of the plurality of heterogeneous operating systems, and by controlling to install a second installation file of the application corresponding to a second of the plurality of heterogeneous operating systems.

10. The electronic apparatus of claim 9, wherein the processor further controls the installation of the application on each of the plurality of heterogeneous operating systems by receiving first feedback indicating success of the installation of the first installation file before proceeding with installation of the second installation file.

11. The electronic apparatus of claim 8, wherein the processor comprises a solution manager module corresponding to firmware of a primary operating system of the plurality of heterogeneous operating systems.

12. A method of installing an application on an electronic apparatus including a plurality of heterogeneous operating systems, the method comprising:
receiving an application file including meta data and a plurality of installation files corresponding to the plurality of heterogeneous operating systems;
parsing the application file; and
installing the application on each of the plurality of heterogeneous operating systems.

13. The method of claim 12, wherein the installing of the application on each of the plurality of heterogeneous operating systems comprises:
installing a first installation file of the application corresponding to a first of the plurality of heterogeneous operating systems; and
installing a second installation file of the application corresponding to a second of the plurality of heterogeneous operating systems.

14. The method of claim 12, further comprising:
receiving first feedback indicating success of the installation of the first installation file before proceeding with installation of the second installation file.

15. The method of claim 12, wherein the meta data comprises a plurality of sets of application meta data respectively corresponding to the plurality of heterogeneous operating systems.
